(19) United States
(12) Patent Application Publication
(10) Pub. No.: US 2015/0185509 A1
(43) Pub. Date: Jul. 2, 2015

(54) METHOD FOR IMPROVING IMAGE STABILITY OF ELECTROPHORETIC FLUID

(71) Applicant: E Ink California, LLC, Fremont, CA (US)

(72) Inventors: Ming WANG, Fremont, CA (US); Peter Laxton, Alameda, CA (US); Hui Du, Milpitas, CA (US); HongMei Zang, Fremont, CA (US)

(21) Appl. No.: 14/588,121

(22) Filed: Dec. 31, 2014

Related U.S. Application Data
(60) Provisional application No. 61/923,178, filed on Jan. 2, 2014.

(51) Int. Cl. G02F 1/00

(52) U.S. Cl. CPC G02F 1/0018

(57) ABSTRACT

The present invention is directed to a display fluid comprising composite pigment particles dispersed in a solvent. The composite pigment particles may exhibit dual functions, that is, they may provide a color to a display device, and also modify the rheology of the fluid without affecting the image switching speed.

This application claims the benefit of U.S. Provisional Application No. 61/923,178, filed Jan. 2, 2014; which is incorporated herein by reference in its entirety.

### FIELD OF THE INVENTION

The present invention is directed to a method for improving image stability of electrophoretic display. The method may involve modifying the rheology of an electrophoretic fluid.

### BACKGROUND OF THE INVENTION

An electrophoretic display (EPD) is a non-emissive device based on the electrophoresis phenomenon influencing charged pigment particles dispersed in a solvent or solvent mixture. An EPD typically comprises a pair of spaced-apart plate-like electrodes. At least one of the electrode plates, typically on the viewing side, is transparent. An electrophoretic fluid composed of a solvent or solvent mixture with charged pigment particles dispersed therein is enclosed between the two electrode plates.

An electrophoretic fluid may have one type of charged pigment particles dispersed in a solvent or solvent mixture of a contrasting color. In this case, when a voltage difference is imposed between the two electrode plates, the pigment particles migrate by attraction to the plate of polarity opposite that of the pigment particles. Thus, the color showing at the transparent plate may be either the color of the solvent or the color of the pigment particles. Reversal of plate polarity will cause the particles to migrate back to the opposite plate, thereby reversing the color.

Alternatively, an electrophoretic fluid may have two types of pigment particles of contrasting colors and carrying opposite charges, and the two types of pigment particles may be dispersed in a clear solvent or solvent mixture. In this case, when a voltage difference is imposed between the two electrode plates, the two types of pigment particles would move to the opposite ends. Thus one of the colors of the two types of the pigment particles would be seen at the viewing side.

In another alternative, color pigment particles are added to an electrophoretic fluid for forming a highlight or multicolor display device.

For an electrophoretic display with one or two types of charged pigment particles, the currently known polymer rheology modifiers (such as polystyrene and ethylene/propylene copolymer, polyisobutylene or star-shaped polymethacrylate) may improve image stability without too much impact on the image switching speed. However, when a third type of charged pigment particles is added to the electrophoretic display fluid, especially if the third type of particles is driven with a lower driving voltage potential, the switching speed seemed to be negatively affected by the addition of the currently known polymer rheology modifiers.

### BRIEF DESCRIPTION OF THE DRAWINGS

FIGS. 1A, 1B and 1C depict composite pigment particles.

FIG. 2 illustrates the living radical dispersion polymerization.

FIG. 3 is a chart of viscosity versus shear stress.

### SUMMARY OF THE INVENTION

The present invention is directed to a method for improving image stability of an electrophoretic display, which method comprises:

a) forming an electrophoretic fluid, and

b) adding composite pigment particles to the electrophoretic fluid, wherein each of the composite pigment particles comprises at least one core pigment particle, an organic shell completely or partially coated over the core pigment particle and polymer stabilizers of polysiloxane or polyisobutylene.

In one embodiment, the organic shell is formed of a material which is either completely incompatible or relatively incompatible with the electrophoretic fluid in which the composite pigment particles are dispersed.

In one embodiment, the organic shell is formed of polymethacrylate, polyacrylate, polystyrene, polyvinylpyrolinone, polyacrylamide or the like.

In one embodiment, the organic shell is formed of polymethyl methacrylate.

In one embodiment, the polymer stabilizers are formed of polysiloxane.

In one embodiment, the added composite pigment particles takes up 2% to 20% in volume of the electrophoretic fluid or 5% to 10% in volume of the electrophoretic fluid.

In one embodiment, the added composite pigment particles are capable of generating a non-black and non-white color state for the electrophoretic display.

In one embodiment, the added composite pigment particles create shear thinning effect in the electrophoretic fluid.

In one embodiment, the image stability of the electrophoretic display is improved via modifying rheology of the electrophoretic fluid.

In one embodiment, the core pigment particle is formed from an inorganic material. In one embodiment, the core pigment particle is formed from an organic material.

In one embodiment, the composite pigment particle has a polymer content of at least 20% by weight.

In one embodiment, the electrophoretic fluid further comprises a charge control agent.

In one embodiment, the electrophoretic fluid comprises a first type and a second type of charged pigment particles dispersed in a solvent or solvent mixture and the added composite pigment particles are driven at a lower driving voltage potential than the first and second types of charged pigment particles. In one embodiment, the composite pigment particles which are driven at a lower driving voltage potential have a charge level being less than 50% of the charge levels of the first and second types of charged pigment particles. In one embodiment, the composite pigment particles which are driven at a lower driving voltage potential have a charge level being 5% to 30% of the charge levels of the first and second types of charged pigment particles.

In one embodiment, the added composite pigment particles are transparent. In one embodiment, the added composite pigment particles are white. In one embodiment, the added composite pigment particles are non-charged.

### DETAILED DESCRIPTION OF THE INVENTION

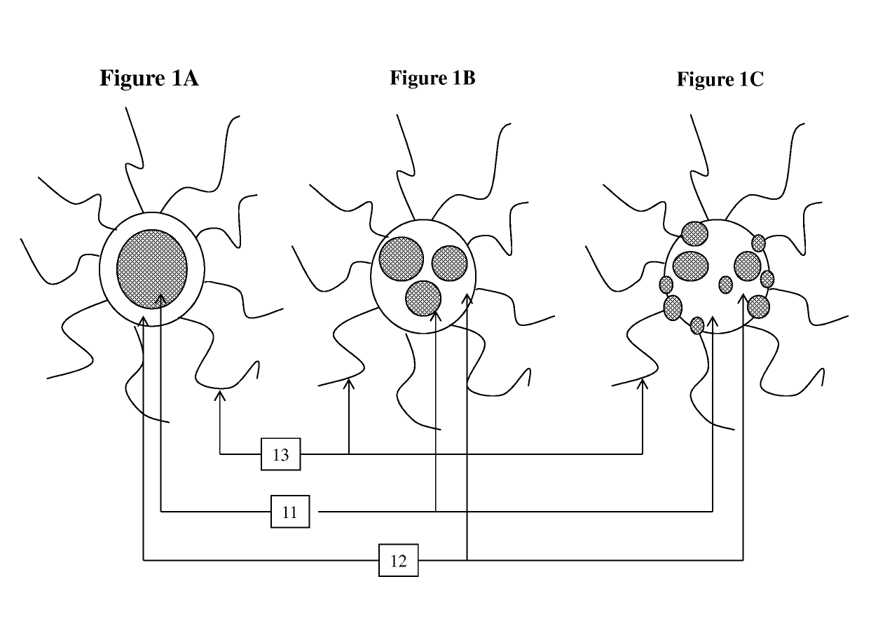

The present invention is directed to composite pigment particles which are useful for improving image stability of an electrophoretic display. The composite pigment particles, as shown in FIGS. 1A-1C, are previously used for generating colors in an electrophoretic display.

In FIGS. 1A-1C, the composite pigment particles may have one or more core pigment particles (11). The core particle(s) (11) is/are completely or partially coated with a shell (12). There are polymer stabilizers (13) on the surface of the composite pigment particles.

The present inventors have now found that one particular type of composite pigment particles wherein each comprises (i) at least one core pigment particle, (ii) an organic shell completely or partially coated over the core pigment particle, and (iii) polymer stabilizers of polysiloxane or polyisobutylene, provides a surprising advantage when added in an electrophoretic fluid. They not only can generate color, but also can improve image stability of a display device utilizing the fluid.

In the context of the present invention, the core pigment particles (11) may be of any colors (e.g., black, white, red, green, blue, cyan, magenta, yellow or the like). The resulting composite pigment particles may also be of any colors, including white. The resulting composite pigment particles may also be transparent.

The core pigment particles (11) may be formed from an inorganic material, such as TiO₂, BaSO₄, ZnO, metal oxides, manganese ferrite black spinel, copper chromite black spinel, carbon black or zinc sulfide.

The core pigment particles (11) may also be formed from an organic material, such as CI pigment PR 254, PR122, PR149, PG36, PG58, PG7, PY138, PY150, PY20, PB15 or the like, which are commonly used organic pigment materials described in the color index handbooks, “New Pigment Application Technology” (CMC Publishing Co, Ltd, 1986) and “Printing Ink Technology” (CMC Publishing Co, Ltd, 1984). Specific examples may include Clariant Hostaperm Red D3G 70-EDS, Hostaperm Pink E-EDS, PV fast red D3G, Hostaperm red D3G 70, BASF Irgazine red L 3630, Cinquasia Red L 4100 HD, Irgazin Red L 3660 HD and the like. The composite pigment particles formed from the organic core particles are usually colored, such as red, green, blue, cyan, magenta, yellow or the like.

The core particles may be optionally surface treated. The surface treatment would improve compatibility of the core pigment particles to the monomer (for forming the shell) in a reaction medium or chemical bonding with the monomer. As an example, the surface treatment may be carried out with an organic silane having functional groups, such as acrylate, vinyl, —NH₂, —NCO, —OH or the like. These functional groups may undergo chemical reaction with the monomers.

The material for the shell (12) is either completely incompatible or relatively incompatible with the display fluid in which the composite pigment particles are dispersed. “Relatively incompatible” as used herein, means that no more than about 5%, preferably no more than about 1%, of the shell material is miscible with the display fluid.

The shell may be formed from an organic polymer, and in the present case, the shell may be formed of polymethacrylate, polyacrylate, polystyrene, polyvinylpyrolinone, polyacrylamide or the like.

The density of the shell, in any case, is preferably low, lower than 2 g/cm³ and more preferably about 1 g/cm³. The shell thickness may be controlled, based on the density of the shell material and the desired final particle density.

Furthermore, the surface of the shell may optionally have functional groups that would enable charge generation or interaction with a charge control agent.

The polymer stabilizers of polysiloxane or polyisobutylene should be compatible with the solvent in which the composite pigment particles are dispersed to facilitate dispersion of the composite pigment particles in the solvent. While not shown, the polymer stabilizers may be branched.

The polymer stabilizers of polysiloxane may be formed from polyorganosiloxane macromonomers, as shown below.

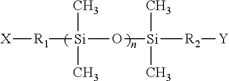

wherein:
X is absent or an initiator residue;
R₁ is absent, a hydrogen atom, a C₁₋₈ alkyl, a halogenated alkyl or an aryl;
R₂ is absent, a C₁₋₈ alkyl, a halogenated alkyl or an aryl;
Y is a polymerizable group, such as a vinyl, an acrylate or a methacrylate.

One specific type of macromonomer for forming the polysiloxane polymer stabilizer is methacrylate terminated polysiloxane (Gelest, MCR-M11, MCR-M17, MCR-M22), as shown below:

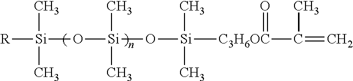

The polymer stabilizers of polyisobutylene may be formed from a polyisobutylene based end-functionalized macromonomer, as shown below:

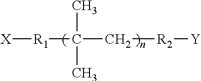

wherein:
X is absent or an initiator residue;
R₁ is absent, a hydrogen atom, a C₁₋₈ alkyl, a halogenated alkyl or an aryl;
R₂ is absent, a C₁₋₈ alkyl, a halogenated alkyl or an aryl;
Y is a polymerizable group, such as a vinyl, an acrylate or a methacrylate.

One specific type of polyisobutylene functionalized macromonomer useful for the present invention is mentioned in US Publication No. 2012-0077934.

Macromonomers are relatively high molecular weight species with a single functional polymerizable group which, although used as monomers, have high enough molecular weight or internal monomer units to be considered polymers. A macromonomer has one end-group which enables it to act as a monomer molecule, contributing only a single monomeric unit to a chain of the final macromolecule.

The preparation of the composite pigment particles of the present invention may be accomplished by a variety of techniques.

For example, they may be formed by dispersion polymerization. During dispersion polymerization, monomer (e.g., methyl methacrylate) is polymerized around core pigment particles in the presence of polysiloxane or polyisobutylene functionalized macromonomers soluble in the reaction medium. The solvent selected as the reaction medium must be a good solvent for both the monomer and the macromonomers, but a non-solvent for the polymer shell being formed. For example, in an aliphatic hydrocarbon solvent of Isopar G®, monomer methylmethacrylate is soluble; but after polymerization, the resulting polymethylmethacrylate is not soluble.

To incorporate functional groups for charge generation, a co-monomer may be added in the reaction medium. The co-monomer may either directly charge the composite pigment particles or have interaction with a charge control agent in the display fluid to bring a desired charge polarity and charge density to the composite pigment particles. Suitable co-monomers may include vinylbenzylaminoethylamino-propyl-trimethoxysilane, methacryloxypropyltrimethoxysilane, acrylic acid, methacrylic acid, vinyl phosphoric acid, 2-acrylamino-2-methylpropane sulfonic acid, 2-(dimethylamino)ethyl methacrylate, N-[3-(dimethylamino)propyl]methacrylamide and the like.

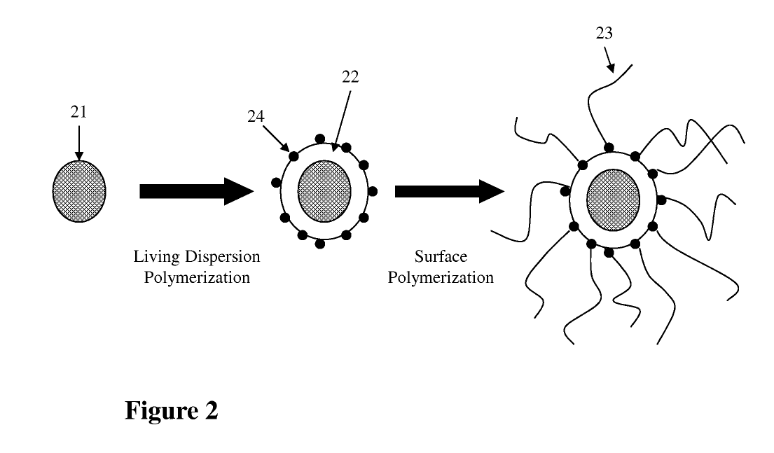

Alternatively, the composite pigment particles may be prepared by living radical dispersion polymerization, as shown in FIG. 2.

The living radical dispersion polymerization technique is similar to the dispersion polymerization described above by starting the process with core pigment particles (21) and monomer (e.g., methyl methacrylate) dispersed in a reaction medium.

In this alternative process, multiple living ends (24) are formed on the surface of the shell (22). The living ends may be created by adding an agent such as TEMPO (2,2,6,6-tetramethyl-1-piperidinyloxy), a RAFT (reversible addition-fragmentation chain transfer) reagent or the like, in the reaction medium, for the living radical polymerization.

In a further step, a second monomer (i.e., a polysiloxane or polyisobutylene functionalized macromonomer) is added to the reaction medium to cause the living ends (24) to react with the second monomer to form the polymer stabilizers (23).

When the polymer stabilizers are prepared through living radical polymerization, a co-monomer may also be added to generate charge. Suitable co-monomers may include vinylbenzylaminoethylaminopropyl-trimethoxysilane, methacryloxypropyltrimethoxysilane, acrylic acid, methacrylic acid, vinyl phosphoric acid and the like.

In the preparation of the composite pigment particles, the quantities of the reagents used (e.g., the core pigment particles, the shell material and the material for forming the polymer stabilizers) may be adjusted and controlled to achieve the desired organic or polymeric content in the resulting composite pigment particles.

The “polymer content” of the composite pigment particles is preferably at least about 20% by weight, preferably about 20% to about 70% by weight and more preferably about 30% to about 45% by weight. In this embodiment, the term “polymer content” is determined by the total weight of the shell (12) and the steric stabilizers (13) divided by the total weight of the core pigment particles (11), the shell (12) and the steric stabilizers (13).

An electrophoretic fluid comprises charged pigment particles dispersed in a solvent or solvent mixture. There may be one, two or more types of charged pigment particles in the fluid.

The composite pigment particles as described above are added into the fluid. They may be charged or uncharged. When charged, they can move in the fluid, depending on the voltage potential applied to the fluid. The charge level carried by this type of particles may be lower than other types of charged pigment particles in the fluid. When present in the fluid, the composite pigment particles may provide a color to the fluid. For example, in an electrophoretic fluid which comprises black and white charged pigment particles, the composite pigment particles added may be of a red color which would allow the display device to display images of red, black and white colors.

In one embodiment, the term “charge intensity” or charge level” may be measured in terms of zeta potential. In one embodiment, the zeta potential is determined by Colloidal Dynamics AcoustoSizer IIM with a CSPU-100 signal processing unit, ESA EN# Attn flow through cell (K:127). The instrument constants, such as density of the solvent used in the sample, dielectric constant of the solvent, speed of sound in the solvent, viscosity of the solvent, all of which at the testing temperature (25° C.) are entered before testing. Pigment samples are dispersed in the solvent (which is usually a hydrocarbon fluid having less than 12 carbon atoms), and diluted to between 5-10% by weight. The sample also contains a charge control agent (Solsperse 17000®, available from Lubrizol Corporation, a Berkshire Hathaway company; “Solsperse” is a Registered Trade Mark), with a weight ratio of 1:10 of the charge control agent to the particles. The mass of the diluted sample is determined and the sample is then loaded into the flow through cell for determination of the zeta potential.

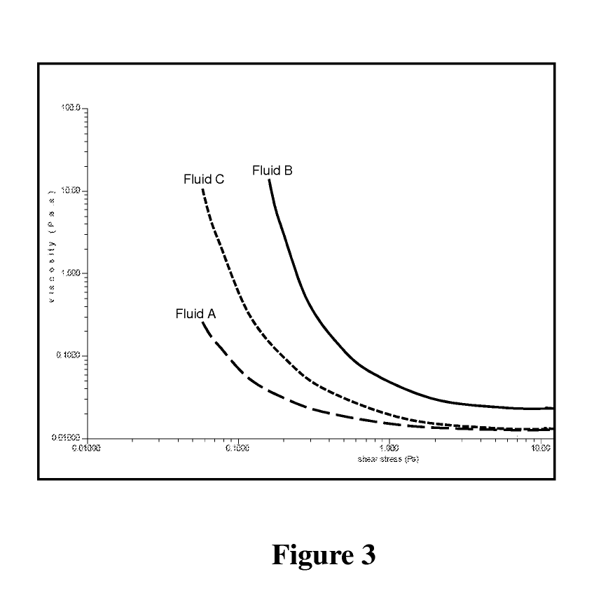

When the composite pigment particles are added into an electrophoretic fluid for forming a display device which may display images of multiple colors, the rheology of the fluid can also be modified without affecting the switching speed of the images. In other words, the image stability of the display device may be improved. This phenomenon is further illustrated in Example 2 below and FIG. 3.

The electrophoretic fluid may comprise 2% to 20%, preferably 5% to 10%, in volume of the composite pigment particles to improve image stability.

The solvent in the fluid may have a low dielectric constant (preferably about 2 to 3), a high volume resistivity (preferably about 1,015 ohm-cm or higher) and a low water solubility (preferably less than 10 parts per million). Suitable hydrocarbon solvents may include, but are not limited to, dodecane, tetradecane, the aliphatic hydrocarbons in the Isopar® series (Exxon, Houston, Tex.) and the like. The solvent can also be a mixture of a hydrocarbon and a halogenated carbon or silicone oil based material.

The density of the composite pigment particles may be substantially matched to the solvent, thus improving performance of the display device. In other words, the difference between the density of the composite pigment particles and the density of the solvent is less than 2 g/cm³, more preferably less than 1.5 g/cm³ and most preferably less than 1 g/cm³.

The composite pigment particles, if charged, may also exhibit a natural charge, or may be charged explicitly using a charge control agent, or may acquire a charge when suspended in an organic solvent. Suitable charge control agents are well known in the art; they may be polymeric or non-polymeric in nature, and may also be ionic or non-ionic, including ionic surfactants such as sodium dodecylbenzenesulfonate, metal soap, polybutene succinimide, maleic anhydride copolymers, vinylpyridine copolymers, vinylpyrrolidone copolymer, (meth)acrylic acid copolymers or N,N-dimethylaminoethyl (meth)acrylate copolymers), Alcolec LV30 (soy lecithin), Petrostep B100 (petroleum sulfonate) or B70 (barium sulfonate), Solsperse 17000 (active polymeric dispersant), Solsperse 9000 (active polymeric dispersant), OLOA 11000 (succinimide ashless dispersant), OLOA 1200 (polyisobutylene succinimides), Unithox 750 (ethoxylates), Petronate L (sodium sulfonate), Disper BYK 101, 2095, 185, 116, 9077 & 220 and ANTI-TERRA series.

### EXAMPLES

### Example 1

### Synthesis of Composite Pigment Particles

Hostaperm Red D3G 70-EDS (Clariant, 2.5 g), methyl methacrylate (8 g) and toluene (2 g) were added into a 20 ml vial and sonicated for 2 hours. To a 250 mL reactor, the above mixture, MCR-M22 (monomethacryloxypropyl terminated polydimethylsiloxane, Gelest, 5.7 g) and DMS-T01 (polydimethylsiloxane, Gelest, 30 g) were added. The reactor was heated to 70° C. with magnetic stirring and purged with nitrogen for 20 minutes, followed by the addition of lauroyl peroxide (0.07 g). After 19 hours, the mixture was centrifuged at 5000 rpm for 15 minutes. The solids produced were redispersed in hexane and centrifuged. This cycle was repeated twice and the solids were dried at room temperature under vacuum to produce the final particles. The polymer content of the particles produced was about 49% by weight, tested through TGA (thermal gravimetric analysis).

### Example 2

### Electrophoretic Fluid and Electro-Optical Performance Measurements

Three types of fluids were tested and the results are summarized in FIG. 3 which shows shear stress versus viscosity.

Fluid A comprises two types of charged particles, 5 wt % polymer coated black and 30 wt % polymer coated white, dispersed in Isopar E with 0.6% of a charge control agent, Solsperse 17000K (Avecia Ltd.). The black and white particles were prepared according to the methods described in US2014/0339480 and US2012/0313049, both of which are incorporated herein by reference in their entirety.

Fluid B comprises the same amounts of the two types of charged particles and Solsperse 17000K as Fluid A, and 1.5 wt % previously known polymer type rheology modifier, polyisobutylene (MW: 850K).

Fluid C comprises the same amounts of the two types of charged particles and Solsperse 17000K as Fluid A, and 8% of the composite pigment particles as described in Example 1 above.

| Fluid | Black pigment | White pigment | Additive for Rheology |
|---|---|---|---|
| A | ✓ | ✓ | None |
| B | ✓ | ✓ | Polymer (PIB) 1.5% |
| C | ✓ | ✓ | Composite Particles 8% |

As shown in FIG. 3, the viscosity of Fluid C is lower than that of Fluid B at both low and high shear stresses. As a result, the switching speed of Fluid C is higher than that of Fluid B under both low and high voltage driving. The viscosity of Fluid A remains almost constant.

Three fluids were injected into a 25 um gap ITO-glass testing cell made by two pieces of 1 mm thick ITO glass. The electro-optic properties were evaluated by applying +/−15V and 350 ms DC voltage between the two ITO sides to achieve either black or white optical state. The optical L* was measured using Xrite iOne D65 standard luminance condition, right after driving or after 10 minute storage at 25° C. without further driving. Table 1 below shows the bistability performance of the three fluids.

TABLE 1

| | White | White | | | | |
|---|---|---|---|---|---|---|
| Type | state | After | | Black | | K- |
| of | Initial | 10 mins | W-bistability | Initial | Black After | bistability |
| Fluid | (L*) | (L*) | loss (ΔL*) | (L*) | 10 mins (L*) | loss (ΔL*) |
| A | 62 | 48 | 14 | 7 | 17 | 10 |
| B | 62 | 52 | 10 | 7 | 14 | 7 |
| C | 62 | 60 | 2 | 7 | 10 | 3 |

From the results in Table 1, the composite pigment particles (Fluid C) were shown to be a more effective rheology modifier. They provide good image stability and are capable of modifying rheology of the fluid without affecting the switching speed.

While the present invention has been described with reference to the specific embodiments thereof, it should be understood by those skilled in the art that various changes may be made and equivalents may be substituted without departing from the scope of the invention.

What is claimed is:

1. A method for improving image stability of an electrophoretic display, which method comprises:
c) forming an electrophoretic fluid, and
d) adding composite pigment particles to the electrophoretic fluid, wherein each of the composite pigment particles comprises at least one core pigment particle, an organic shell completely or partially coated over the core pigment particle and polymer stabilizers of polysiloxane or polyisobutylene.

2. The method of claim 1, wherein the organic shell is formed of a material which is either completely incompatible or relatively incompatible with the electrophoretic fluid in which the composite pigment particles are dispersed.

3. The method of claim 1, wherein the organic shell is formed of polymethacrylate, polyacrylate, polystyrene, polyvinylpyrolinone or polyacrylamide.

4. The method of claim 3, wherein the organic shell is formed of polymethyl methacrylate.

5. The method of claim 1, wherein the polymer stabilizers are formed of polysiloxane.

6. The method of claim 1, wherein the added composite pigment particles takes up 2% to 20% in volume of the electrophoretic fluid.

7. The method of claim 1, wherein the added composite pigment particles takes up 5% to 10% in volume of the electrophoretic fluid.

8. The method of claim 1, wherein the added composite pigment particles are capable of generating a non-black and non-white color state for the electrophoretic display.

9. The method of claim 1, wherein the added composite pigment particles create shear thinning effect in the electrophoretic fluid.

10. The method of claim 1, wherein the image stability of the electrophoretic display is improved via modifying rheology of the electrophoretic fluid.

11. The method of claim 1, wherein the core pigment particle is formed from an inorganic material.

12. The method of claim 1, wherein the core pigment particle is formed from an organic material.

13. The method of claim 1, the composite pigment particle has a polymer content of at least 20% by weight.

14. The method of claim 1, wherein the electrophoretic fluid further comprises a charge control agent.

15. The method of claim 1, wherein the electrophoretic fluid comprises a first type and a second type of charged pigment particles dispersed in a solvent or solvent mixture and the added composite pigment particles are driven at a lower driving voltage potential than the first and second types of charged pigment particles.

16. The method of claim 15, wherein the composite pigment particles which are driven at a lower driving voltage potential have a charge level being less than 50% of the charge levels of the first and second types of charged pigment particles.

17. The method of claim 15, wherein the composite pigment particles which are driven at a lower driving voltage potential have a charge level being 5% to 30% of the charge levels of the first and second types of charged pigment particles.

18. The method of claim 1, wherein the added composite pigment particles are transparent.

19. The method of claim 1, wherein the added composite pigment particles are white.

20. The method of claim 1, wherein the added composite pigment particles are non-charged.
